(19) United States
(12) Patent Application Publication
(10) Pub. No.: US 2024/0380968 A1
(43) Pub. Date: Nov. 14, 2024

(54) SYSTEMS AND METHODS FOR OBTAINING A SMART PANORAMIC IMAGE

(71) Applicant: Corephotonics Ltd., Tel Aviv (IL)

(72) Inventors: Avia Israeli, Tel Aviv (IL); Nitzan Horovitz, Tel Aviv (IL); Limor Battino, Tel Aviv (IL); Yoav Kurtz, Tel Aviv (IL); Noy Cohen, Tel Aviv (IL)

(21) Appl. No.: 18/779,231

(22) Filed: Jul. 22, 2024

Related U.S. Application Data
(63) Continuation of application No. 18/446,502, filed on Aug. 9, 2023, now Pat. No. 12,075,151.
Application No. 18/446,502 is a continuation of application No. 17/614,385, filed on Nov. 26, 2021, now Pat. No. 11,770,618.
(60) Provisional application No. 62/945,519, filed on Dec. 9, 2019.

(51) Int. Cl. H04N 23/611; G06T 7/20; G06V 40/18; H04N 5/262; H04N 23/45; H04N 23/69; H04N 23/698; H04N 23/90

(52) U.S. Cl. CPC H04N 23/611; G06T 7/20; G06V 40/18; H04N 5/2628; H04N 23/45; H04N 23/69; H04N 23/698; H04N 23/90

(57) ABSTRACT

Mobile handheld electronic devices such as smartphones, comprising a Wide camera for capturing Wide images with respective Wide fields of view (FOV_{W}), a Tele camera for capturing Tele images with respective Tele fields of view (FOV_{T}) smaller than FOV_{W}, and a processor configured to stitch a plurality of Wide images into a panorama image with a field of view FOV_{P}>FOV_{W} and to pin a Tele image to a given location within the panorama image to obtain a smart panorama image.

### CROSS-REFERENCE TO RELATED APPLICATIONS

This application is a continuation application of U.S. patent application Ser. No. 18/446,502 filed Aug. 9, 2023 (now allowed), which is a continuation application of U.S. patent application Ser. No. 17/614,385 filed Nov. 26, 2021 (now U.S. Pat. No. 11,770,618), which is a 371 of international patent application PCT/IB2020/061461 filed Dec. 3, 2020, and claims priority from U.S. Provisional Patent Application No. 62/945,519 filed Dec. 9, 2019, which is expressly incorporated herein by reference in its entirety.

### FIELD

The subject matter disclosed herein relates in general to panoramic images and in particular to methods for obtaining such images with multi-cameras (e.g. dual-cameras).

### BACKGROUND

Multi-aperture cameras (or multi-cameras) are becoming the standard choice of mobile device (e.g. smartphone, tablet, etc.) makers when designing cameras for their high-ends devices. A multi-camera setup usually comprises a wide field-of-view (FOV) (or “angle”) aperture (“Wide” or “W” camera), and one or more additional lenses, either with the same FOV (e.g. a depth auxiliary camera), with a narrower FOV (“Telephoto”, “Tele” or “T” camera, with a “Tele FOV” or FOV_{T}) or with Wide FOV (FOV_{W}) or ultra-wide FOV (FOV_{UW}) (“Ultra-Wide” or “UW” camera).

In recent years, panoramic photography has gained popularity with mobile users, as it gives a photographer the ability to capture a scenery and its surroundings with very large FOV (in general in vertical direction). Some mobile device makers have recognized the trend and offer an ultra-wide-angle (or “ultra-Wide”) camera in the rear camera setup of a mobile device such as a smartphone. Nevertheless, capturing a scenery on a single aperture is limited and image stitching is required when a user wishes to capture a large FOV scene.

A panoramic image (or simply “regular panorama”) captured on a mobile device comprises a plurality of FOV_{W} images stitched together. The W image data is the main camera data used for the stitching process, since having a Wide FOV (also marked “FOV_{W}”), the final (stitched) image (referred to as “Wide panorama”) consumes less memory than that required for a Tele camera-based panorama (or simply “Tele panorama”) capturing the same scene. Additionally, the W camera has a larger depth-of-field than a T camera, leading to superior results in terms of focus. In comparison to an ultra-W camera, a W camera also demonstrates superior results in terms of distortion.

Since a Wide panorama is limited by a Wide image resolution, the ability to distinguish between fine details, mainly of far objects, is limited. A user who wishes to zoom in towards an “object of interest” (OOI) within the panorama image, i.e. perform digital zoom, will notice a blurred image due to Wide image resolution limits. Moreover, the panoramic image may be compressed to an even lower resolution than Wide image resolution in order to meet memory constraints.

There is need and it would be beneficial to combine the benefits of a panorama image having a very large FOV and Tele images having a large image resolution.

### SUMMARY

To increase the resolution of OOIs, systems and methods for obtaining a “smart panorama” are disclosed herein. A smart panorama comprises a Wide panorama and at least one Tele-based image of an OOI captured simultaneously. That is, a smart panorama as described herein refers to an image data array comprising (i) a panorama image as known in the art and (ii) a set of one or more high-resolution images of OOIs that are pinned or located within the panorama FOV. While the panorama is being captured, an additional process analyzes the W camera FOV_{W} scene and identifies OOIs. Once an OOI is identified, the “best camera” is chosen out of the multi-camera array. The “best camera” selection may be between a plurality of cameras, or it may be between a single Tele camera having different operational modes such as different zoom states or different points of view (POVs). The “best camera” selection may be based on the OOI's object size, distance from the camera etc., and a capture request to the “best camera” is issued. The “best camera” selection may be defined by a Tele capture strategy such as described below. In some embodiments with cameras that have different optical zoom states, the “best camera” may be operated using a beneficial zoom state. In other embodiments with cameras that have a scanning FOV the “best camera” may be directed towards that OOI.

Note that a method disclosed herein is not limited to a specific multi-camera module and could be used for any combination of cameras as long as the combination consists of at least two cameras with a FOV ratio different than 1.

In current multi-camera systems, the FOV_{T} is normally in the center part of the FOV_{W}, defining a limited strip where interesting objects that have been detected trigger a capture request. A Tele camera with a 2D scanning capability extends the strip such that any object detected in the scanning range could be captured, i.e. provides “zoom anywhere”. Examples of cameras with 2D scanning capability may be found in co-owned international patent applications PCT/IB2016/057366, PCT/IB2019/053315 and PCT/IB2018/050988.

Tele cameras with multiple optical zoom states can adapt the zoom (and FOV_{T}) according to e.g. size and distance of OOIs. Cameras with that capability may be found for example in co-owned US international patent applications No. PCT/IB2020/050002 and PCT/IB2020/051405.

The panorama being displayed to the user will contain some differentiating element marking the area of the panorama where high resolution OOI image information is present, such differentiating element marking may include, for example, a touchable rectangle box. By touching the box, the full resolution optically zoomed image will be displayed, allowing the user to enjoy both the panoramic view and the high-resolution zoom-in view.

In various embodiments there are provide handheld mobile electronic devices, comprising: a Wide camera for capturing Wide images, each Wide image having a respective Wide field of view (FOV_{W}); a Tele camera for capturing Tele images, each Tele image having a respective Tele field of view (FOV_{T}) smaller than FOV_{W}; and a processor configured to stitch a plurality of Wide images with respective FOV_{W} into a panorama image with a field of view FOV_{P}>FOV_{W} and to pin a Tele image to a given location within the panorama image to obtain a smart panorama image.

In some embodiments, each Wide image includes Wide scene information that is different from scene information of other Wide images.

In some embodiments, the processor is configured to crop the Tele image before pinning it to the given location.

In some embodiments, the Tele images are cropped according to aesthetic criteria.

In some embodiments, the Wide camera is configured to capture Wide images autonomously.

In some embodiments, the Tele camera is configured to capture the Tele images autonomously.

In some embodiments, the processor is configured to use a motion model that predicts a future movement of the handheld device.

In some embodiments, the processor is configured to use a motion model that predicts a future movement of an object within the FOV_{P}.

In some embodiments, the processor is configured to use particular capture strategies for the autonomous capturing of the Tele images.

In some embodiments, the pinning a Tele image to a given location within the panorama image is obtained by executing localization between the Wide images and Tele images.

In some embodiments, the pinning a Tele image to a given location within the panorama image is obtained by executing localization between the panorama image and Tele images. In some embodiments, the Tele camera has a plurality of zoom states.

In some embodiments, the processor is configured to autonomously select a particular zoom state from the plurality of zoom states.

In some embodiments, a particular zoom state from the plurality of zoom states is selected by a human user.

In some embodiments, the plurality of zoom states includes a discrete number.

In some embodiments, at least one of the plurality of zoom states can be modified continuously.

In some embodiments, the Tele camera is a scanning Tele camera.

In some embodiments, the processor is configured to autonomously direct scanning of the FOV_{T} to a specific location within a scene.

In some embodiments, the FOV_{T} scanning is performed by rotating one optical path folding element.

In some embodiments, the FOV_{T} scanning is performed by rotating two or more optical path folding elements.

In some embodiments, each Tele image includes scene information from a center of the panorama image.

In some embodiments, scene information in the Tele images includes scene information from a field of view larger than a native Tele field of view and smaller than a Wide field of view.

In some embodiments, a particular segment of a scene is captured by the Tele camera and is pinned to locations within the panorama image.

In some embodiments, the processor uses a tracking algorithm to capture the particular segment of a scene with the Tele camera.

In some embodiments, a program decides which scene information captured by the Tele camera and pinned to locations within the panorama image.

In some embodiments, the processor is configured to calculate a saliency map based on Wide image data to decide which scene information is captured by the Tele camera and pinned to locations within the panorama image.

In some embodiments, the processor is configured to use a tracking algorithm to capture scene information with the Tele camera.

In some embodiments, the Tele image pinned to a given location within the panorama image is additionally shown in another location within the panorama image.

In some embodiments, the Tele image pinned to a given location within the panorama image is shown in an enlarged scale.

In various embodiments there are provided methods, comprising: providing a plurality of Wide images, each Wide image having a respective FOV_{W} and including Wide scene information different from other Wide images; providing a plurality of Tele images, each Tele image having a respective FOV_{T} that is smaller than FOV_{W}; using a processor for stitching a plurality of Wide images into a panorama image with a panorama field of view FOV_{P}>FOV_{W}; and using the processor to pin at least one Tele image to a given location within the panorama image.

In some embodiments, the handheld device is manually moved by a user to capture scene information in the FOV_{P}.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale. In the drawings:

FIG. 1A illustrates exemplary triple camera output image sizes and ratios therebetween;

FIG. 1B illustrates exemplary ratios between W and T images in a dual-camera, with the T camera in two different zoom states;

FIG. 1C illustrates the FOVs of dual-camera images, for a dual-camera that comprises a 2D scanning T cameras;

FIG. 2A shows a smart panorama image example, in which certain OOIs are objects located in a limited strip around the center of FOV_{W};

FIG. 2B shows a panorama image example in which certain OOIs are located across a large part of the FOV_{W};

FIG. 3A shows an exemplary embodiment of a smart panorama output from a human user perspective;

FIG. 3B shows another exemplary embodiment of a smart panorama output from a human user perspective;

FIG. 3C shows yet another exemplary embodiment of a smart panorama output from a human user perspective.

FIG. 4 shows schematically an embodiment of an electronic device capable of providing smart panorama images as described herein;

FIG. 5 shows a general workflow of the smart panorama method of use as described herein;

FIGS. 6A and 6B show the localization of the T image within the W image.

### DETAILED DESCRIPTION

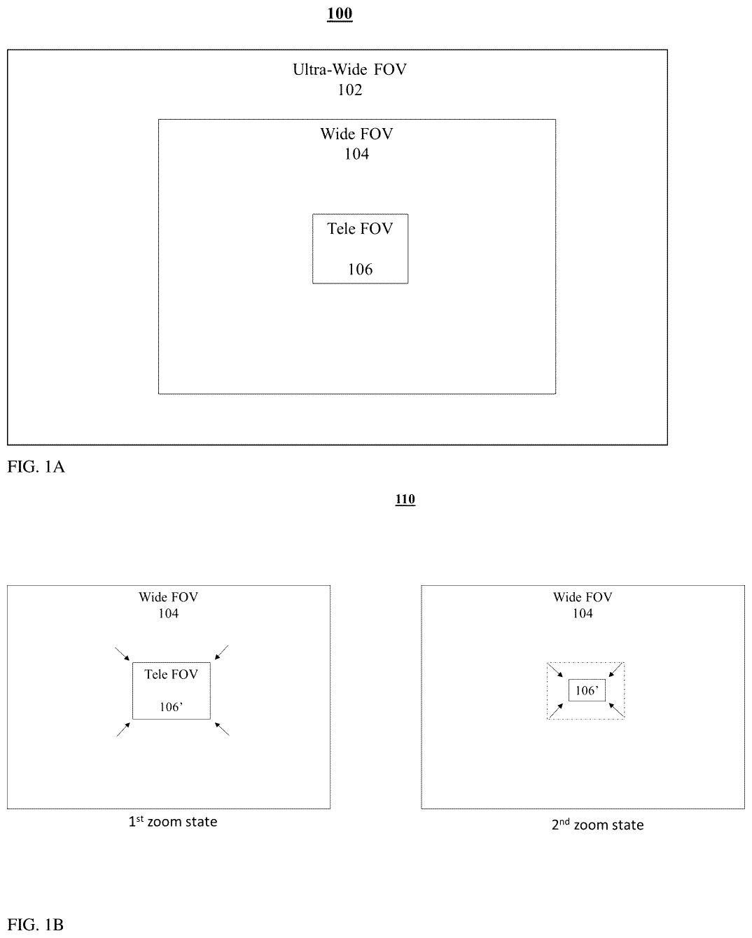

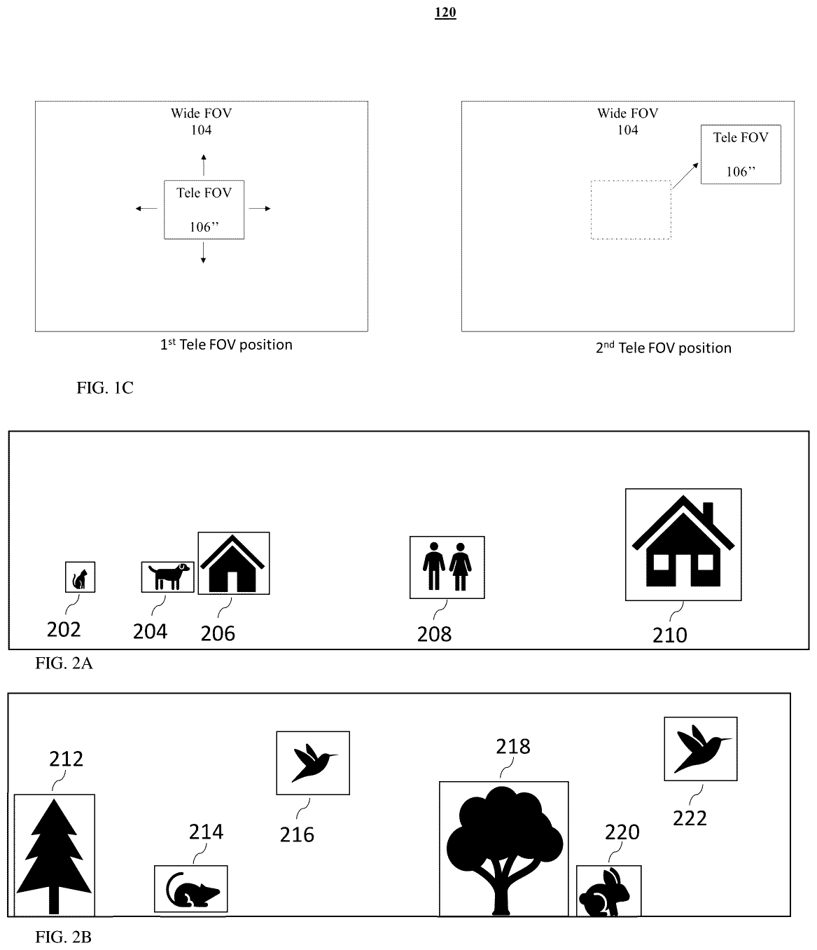

Non-limiting examples of embodiments disclosed herein are described below with reference to figures attached hereto that are listed following this paragraph. The drawings and descriptions are meant to illuminate and clarify embodiments disclosed herein and should not be considered limiting in any way. Like elements in different drawings may be indicated by like numerals. Elements in the drawings are not necessarily drawn to scale. In the drawings: FIG. 1A illustrates exemplary triple camera output image sizes and ratios therebetween. A triple camera includes three cameras having different FOVs, for example an ultra-Wide FOV (marked FOV_{UW}) 102, a Wide FOV (marked FOV_{W}) 104 and a Tele FOV (marked FOV_{T}) 106. Such a triple camera is applicable for the “smart panorama” method disclosed herein. Either of the UW or W cameras can be used as a “Wide camera” in a method of obtaining a smart panorama disclosed herein, and the Tele camera can be used to capture high-resolution images of OOIs within a capture time needed to capture the panorama.

FIG. 1B illustrates exemplary ratios between W and T images in a dual-camera comprising a Wide camera and a Tele camera, with the Tele camera in two different zoom states, 1^{st} zoom state and 2^{nd} zoom state. Here, the 2^{nd} zoom state refers to a state with a higher zoom factor ZF (and smaller corresponding FOV) than the 1st zoom state. The W camera has a FOV_{W} 104. The T camera is a zoom Tele camera that can adapt its zoom factor (and a corresponding FOV 106′), either between 2 or more discrete zoom states of e.g. x5 zoom and x8 zoom, or between any number of desired zoom states (in the limits of the zoom capability) via continuous zoom. While the panorama image is based on the W image data, it is possible to select a specific FOV_{T} 106′ (and corresponding zoom factor) and use this specific FOV_{T} 106′ to capture OOIs so that a best user experience is provided for the smart panorama image.

FIG. 1C illustrates the FOVs of dual-camera images, for a dual-camera that comprises a 2D scanning T camera. A 2D scanning T camera has a “native FOV_{T}” wherein the location of the native FOV_{T} in the scene can be changed, enabling to cover or “scan” a segment of a scene that is larger than the native FOV_{T}. This larger scene segment is referred to as the “effective Tele FOV” or simply “Tele FOV”. FIG. 1C shows a native FOV_{T} 106″ at two different positions within FOV_{W} 104. The W camera with FOV_{W} 104 is used for capturing a regular panorama. A region-of-interest (ROI) detection method applied to FOV_{W} is used to direct FOV_{T} 106″ towards this ROI. Examples of such detection methods are described below. The FOV scanning may be performed by rotational actuation of one or more optical path folding elements (OPFEs). FOV scanning by actuating an OPFE is not instantaneous, since it requires some settling time. FOV scanning may for example require a time scale of about 1-30 ms for scanning 2°-5°, and about 5-80 ms for scanning 10-25°. In some embodiments, the T camera may cover about 50% of the area of FOV_{W}. In other embodiments, the T camera may cover about 80% or more of the area of FOV_{W}.

Regular panorama images can be captured with vertical or horizontal sensor orientation. The panorama capturing direction could be either left-to-right or right-to-left and can comprise any angle of view up to 360 degrees. This capturing is applicable to spherical, cylindrical or 3D panoramas.

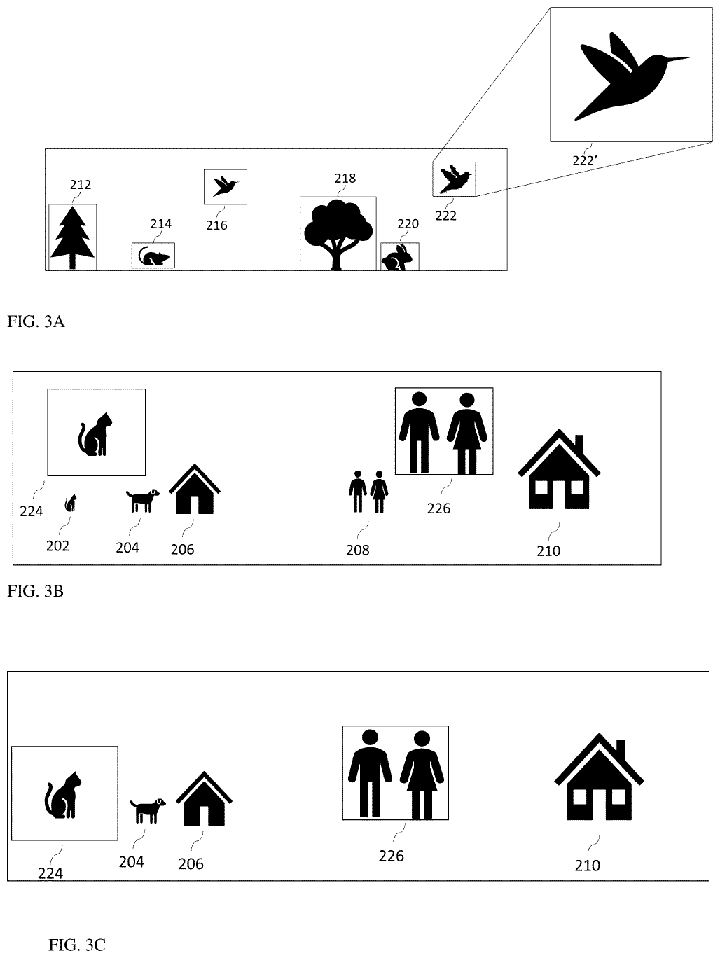

FIG. 2A shows a smart panorama image example, in which OOIs 202, 204, 206, 208 and 210 are objects located in (restricted to) a limited strip around the center of FOV_{W}, the amount of restriction defined by the FOV ratio between e.g. the W and T cameras. This strip corresponds to the FOV of a T camera with no scanning capability. OOIs contained in this strip are detected by the smart panorama process and are automatically captured. With a multi-state zoom camera or a continuous zoom camera as T camera, an object (e.g. 202) occupying a solid angle Ω₂₀₂ in FOV_{W} may be captured with higher image resolution than that of another object 210 (occupying a solid angle Ω₂₁₀ in FOV_{W}, where Ω₂₁₀>Ω₂₀₂).

FIG. 2B shows a panorama image example, in which OOIs 212, 214, 216, 218, 220 and 222 are located across a large part of FOV_{W}. The OOIs may also be restricted to a limited strip, but the limits of this strip are significantly larger than in FIG. 2A. A scanning T camera can capture objects located off-center (e.g. object 222) in the 2D scanning range.

FIG. 3A shows an exemplary embodiment of a smart panorama output from a human user perspective. Objects 212, 214, 216, 218, 220 and 222 identified as OOIs and captured with high T image resolution are marked with a rectangle box that may be visible or may not be visible on the panorama image, hinting to the user the availability of high-resolution images of OOIs. By clicking one of the boxes (e.g. box 222), the high-resolution image is accessed and can be displayed to the user in a number of ways, including, but not limited to: in full image preview; in a side-by-side display together with the smart panorama image; in a zoom-in video display combining the panorama, the W image and the T image; or in any other type of display that uses the available images.

FIG. 3B and FIG. 3C show another exemplary embodiment of a smart panorama output from a human user perspective. FIG. 3B and FIG. 3C refer to the panoramic scene shown inn FIG. 2A. Objects 202 and 208 which are identified as OOIs and captured with high T image resolution may be visible on the panorama image not only in their actual location (and size), but also in an enlarged representation (or scale) such as 224 and 226 for objects 202 and 208 respectively. This enlarged representation may be shown in a suitable segment of the panorama image. A suitable segment may be a segment where no other OOIs are present, where image quality is low, where image artifacts are present, etc. In some examples, this double representation may be used for all OOIs in the scene.

In other examples and as shown in FIG. 3C exemplarily for objects 224 and 226 which are enlarged representations of objects 202 and 208 respectively, one or more OOIs may be shown in their actual location in an enlarged representation.

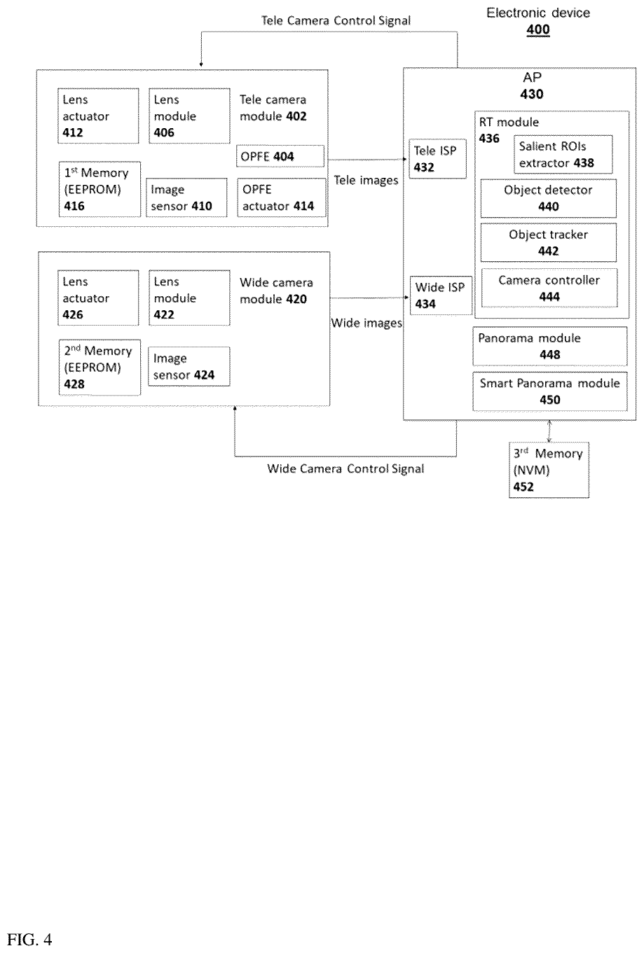

FIG. 4 shows schematically an embodiment of an electronic device (e.g. a smartphone) numbered 400 capable of providing smart panorama images as described herein. Electronic device 400 comprises a first T camera 402, which may be a non-folded (vertical) T camera or a folded T camera that includes one or more OPFEs 404, and a first lens module 406 including a first (Tele) lens that forms a first image recorded by a first image sensor 408. T camera 402 forms an image recorded by a first (Tele) image sensor 410. The first lens may have a fixed effective focal length (fixed EFL) providing a fixed zoom factor (ZF), or an adaptable effective focal length (adaptive EFL) providing an adaptable ZF. The adaptation of the focal length may be discrete or continuous, i.c. a discrete number of varying focal lengths for providing two or more discrete zoom states having particular respective ZFs, or the adaptation of the ZF may be continuous. A first lens actuator 412 may move lens module 406 for focusing and/or optical image stabilization (OIS). An OPFE actuator 414 may actuate OPFE 404 for OIS and/or FOV scanning.

In some embodiments, the FOV scanning of the T camera may be performed not by OPFE actuation. In some embodiments, the FOV scanning of the T camera may be performed not by actuating one OPFE, but by actuating two or more OPFEs. A scanning T camera that performs FOV scanning by actuating two OPFEs is described for example in co-owned U.S. provisional patent application No. 63/110,057 filed Nov. 5, 2020.

Electronic device 400 further comprises a W camera module 420 with a FOV_{W} larger than FOV_{T} of camera module 402. W camera module 420 includes a second lens module 422 that forms an image recorded by a second (Wide) image sensor 424. A second lens actuator 426 may move lens module 422 for focusing and/or OIS. In some embodiments, second calibration data may be stored in a second memory 428.

Electronic device 400 may further comprise an application processor (AP) 430. Application processor 440 comprises a T image signal processor (ISP) 432 and a W image ISP 434. Application processor 430 further comprises a Real-time module 436 that includes a salient ROI extractor 438, an object detector 440, an object tracker 442 and a camera controller 444. Application processor 440 further comprises a panorama module 448 and a smart panorama module 450.

In some embodiments, first calibration data may be stored in a first memory 416 of the T camera module, e.g. in an EEPROM (electrically erasable programmable read only memory). In other embodiments, first calibration data may be stored in a third memory 470 such as a NVM (non-volatile memory). The first calibration data may comprise calibration data between sensors of a W module 420 and the T module 402. In other embodiments, the second calibration data may be stored in third memory 452. The second calibration data may comprise calibration data between sensors of a W module 420 and the T module 402. The T module may have an effective focal length (EFL) of e.g. 8 mm-30 mm or more, a diagonal FOV of 10 deg-40 deg and a f number of about f/#=1.8-6. The W module may have an EFL of e.g. 2.5 mm-8 mm, a diagonal FOV of 50 deg-130 deg and f/#=1.0-2.5.

In use, a processing unit such as AP 430 may receive respective Wide and T image data from camera modules 402 and 420 and supply camera control signals to camera modules 402 and 420.

Salient ROI extractor 438 may calculate a saliency map for each W image. The saliency maps may be obtained by applying various saliency or salient-object-detection (SOD) algorithms, using classic computer vision methods or neural networks models. Examples to saliency methods can be found in datasets known in the art such as the “MIT Saliency Benchmark” and the “MIT/Tuebingen Saliency Benchmark”. Salient ROI extractor 438 also extracts salient Regions-Of-Interest (ROIs) and may contain the OOIs discussed above. For each salient object (or ROI), a surrounding bounding box is defined which may include a scene segment and a saliency score. The saliency score may be used to determine the influence of an object on future decisions as described in later steps. The saliency score is selected as a combination of parameters that reflect object properties, for example the size of the object and a representation of the saliency scores in each object.

In some embodiments, object detector 440 may detect objects in the W image simultaneously to the calculation of the saliency map and provide a semantic understanding of the objects in the scene. The semantic information extracted may be considered in calculating the saliency score.

In other embodiments, object detector 440 may detect objects in the W image after calculation of the saliency map. Object detector 440 may use only segments of the W image, e.g. only segments that are classified as saliency ROIs by salient ROI extractor 438. Object detector 440 may additionally provide a semantic understanding of the ROIs wherein the semantic information may be used to re-calculate the saliency score. Object detector 440 may provide data such as information on an ROI's location and classification type to an object tracker 442, which may update camera controller 444 on the ROI's location as well as to the camera controller 458. Camera controller 444 may consider capturing a ROI in dependence of particular semantic labels or of a ROI's location (e.g. for considering hardware limitation such as a limited Tele FOV coverage of the Wide FOV) within the Wide FOV or of a saliency score above a certain threshold etc.

Panorama module 448 stitches a plurality of W images to a panorama image as known in the art. Smart panorama module 450 matches the high-resolution ROIs to their corresponding locations on the panorama image and to an image selection module (not shown) that selects the T images that are to be used in the smart panorama image.

Camera controller 444 may select or direct the T camera to capture the ROIs according to different Tele capture strategies for providing a best user experience. For providing a best user experience, camera controller 444 may a “best camera” e.g. by selecting a suitable ZF or by directing the native FOV_{T} towards a ROI within the FOV_{T}.

In some examples a “best user experience” may refer to T images of ROIs that provide information on OOIs in highest resolution (Tele capture “strategy example 1” or “SE 1”), and a respective Tele capture strategy that provides this may be selected. However, in other examples a best user experience may be provided by strategy examples such as:
capturing the Tele ROI that contains the OOI with the highest saliency score (“SE 2”); capturing multiple OOIs in one ROI Tele capture (“SE 3”);
a uniform or non-uniform depth-of-field distribution between the different ROI Tele captures (“SE 4”);
including not only the OOI, but also a certain amount of background (“SE 5”) e.g. so that aesthetic cropping can be applied; capturing a plurality of ROIs with a particular zoom factor (“SE 6”);
capturing multiple OOIs in one ROI Tele capture wherein the OOIs may be distributed according to a particular distribution within the Tele FOV (“SE 7”);
capturing one or more OOIs in one ROIs wherein the OOIs are to be located at particular positions or areas within the T image (“SE 8”);
capturing a plurality of ROIs with a particular zoom factors, e.g. so that the images of the ROIs or of particular OOIs which are formed on the image sensor may have a particular image size (“SE 9”);
a particular spectroscopic or colour composition range (“SE 10”);
a particular brightness range (“SE 11”); a particular scene characteristics which may be visual data (“SE 12”) such as texture;
including not only the OOI, but also a certain amount of background wherein the T camera settings may be selected so that the OOI may be in focus and the background may have some particular degree of optical bokeh (“SE 13”) or may have a minimal or maximal degree of optical bokeh (“SE 14”);
capturing with a higher preference specific types of OOIs, e.g. a user may be able to select whether e.g. animals or plants or buildings or humans may be captured by the Tele with a higher preference (“SE 15”); or
capturing a preferred type of OOI with higher preference in some particular state or condition, e.g. a human may be captured with open eyes with a higher preference or a bird may be captured with open wings with higher preference (“SE 16”) etc., or other criteria known in photography may be considered for best user experience.

The Tele capture strategies are respectively defined for providing a best user experience. According to the Tele capture strategy, camera controller 444 may adjust the settings of the T camera, e.g. with respect to a selected zoom factor or to a selected f number or to a POV that the scanning camera may be directed to etc. Other techniques described herein such as the calculation of a saliency map or the application of a motion model or the use of an object tracking algorithm etc. may be used or adapted e.g. by modifying settings to implement a particular Tele capture strategy.

In another embodiment, camera controller 444 may decide to capture a ROI that is a sub-region of an OOI that exceeds the native FOV_{T} boundaries. Such objects will be referred to as “large” objects. When a “large” object is selected, salient ROIs extractor 438 may calculate an additional saliency map on the segment of the Wide FOV that contains the large object. The saliency map may be analysed, and the most visually attentive (salient) sub-region of the large object may be selected to be captured by the T camera. For example, the sub-region may replace the large object data in following calculation steps. Camera controller 444 may direct a scanning T camera towards the sub-region for capturing it.

Smart panorama module 450 may decide whether to save (capture) or discard a T image, e.g. smart panorama module 464 may save only the “best” images out of all T images captured. The best images may be defined as images that contain the largest amount of salient information. In other embodiments, the best images may include particular objects that may be of high value for the individual user, e.g. particular persons or animals. Smart panorama module 450 may e.g. be taught automatically (e.g. by a machine learning procedure) or manually by the user which ROIs are to be considered best images. In yet other embodiments, the best images may be an image captured with a particular zoom factor, or a plurality of images including a ROI each, wherein each ROI may be captured with a particular zoom factor or some other property, e.g. so that the images of the ROIs which are formed on the image sensor may have a particular size, or a particular spectroscopic or colour composition range, or with a minimum degree of focus or defocus, or a particular brightness range, or a particular scene characteristics that may be visual data such as texture. In some embodiments, smart panorama module 450 may verify that newly captured images have non-overlapping FOVs with previously saved (i.e. already selected) images.

In some embodiments, object tracker 442 may track a selected ROI across consecutive W images. Different tracking methods may be used, e.g. Henriques et al. “High-speed tracking with kernelized correlation filters”. The object tracking may proceed until the ROI is captured by the T camera or until the object tracking process fails. In some embodiments, object tracker 442 may be configured as well for predicting a future position of the ROI, e.g. based on a current camera position and some motion model. For this prediction, an extension of a Kalman filter or any other motion estimation as known in the art may be used. Examples to Kalman filter methods can be found in the article “An Introduction to the Kalman Filter”, published by Welch and Bishop in 1995. The position prediction may be used for directing the scanning T camera to an expected future ROI position. In some embodiment, also the estimated velocity of an ROI may be considered. The velocity may refer to the velocity of e.g. an OOI with respect to other objects in the scene or to the velocity of e.g. an OOI with respect to the movement of electronic device 400.

In other embodiments, camera controller 444 may be configured to perform fault detection. The fault detection may for example raise an error in case that a particular threshold in terms of image quality or scene content may not be met. For example, an error may be raised if a certain threshold of (a) motion blur, (b) electronic noise, (c) defocus blur, obstructions in the scene or other undesired effects may be detected in the image. In some examples, in case a ROI image raised an error, this image will not be considered for a smart panorama image, and a scanning T camera may be instructed to re-direct to the scene segment comprising the ROI and to re-capture the ROI.

In other embodiments, camera controller 444 may consider further user inputs for a capture decision. User inputs may be intentional or unintentional. For example, eye tracking may be used to make a capture decision. For example, a user-facing camera may be used to automatically observe the eye movement of a user when watching on a screen of a camera hosting device or on the scene itself. For example, in case a user's eyes stay a significantly longer time on a particular scene segment than they stay on other scene segments, the given segment may be considered important to the user and may be captured with increased priority.

In other embodiments and for example for capturing objects that are large with respect to the Tele FOV or for capturing objects with very high resolution, camera controller 444 may be configured to capture a ROI not by a single T image, but by a plurality of T images that include different segments of an ROI. The plurality of T images may be stitched together to one image that may display the ROI in its entirety.

A final selection of best images may be performed by smart panorama module 450. Smart panorama module 450 may e.g. consider (i) the maximal storage capacity, (ii) FOV overlap across saved images, and (iii) the spatial distribution of the ROIs on a panorama FOV. Smart panorama module 450 additionally includes a cropping module (not shown) that aims to find the cropping window that satisfies criteria such as providing best user experience as described above, as well as criteria from aesthetic image cropping, e.g. as described by Wang et al in the article “A deep network solution for attention and aesthetics aware photo cropping”, 2018.

In some embodiments, smart panorama module 450 may perform an additional saliency calculation on a stitched image with a FOV wider than the Wide FOV. For example, saliency information can be calculated by applying a saliency or SOD model on a segment of, or on the entire the panorama FOV.

In other embodiments, smart panorama module 450 may use semantic information to select T images to be used in the smart panorama image, e.g. by applying a detection algorithm. The chances of selecting a T image to be used in the smart panorama image may e.g. be elevated if human faces were detected by a face-detection algorithm.

The selected T images may be exemplarily displayed to the user via a tap on a rectangle marked on the smart panorama image, or with zoom transition from the smart panorama FOV to the native Tele FOV via zoom pinching.

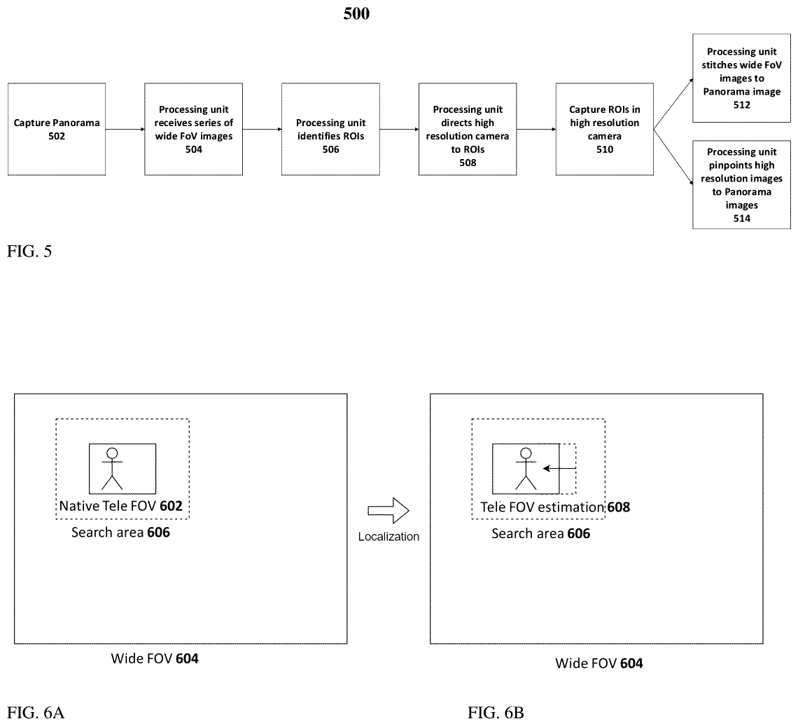

FIG. 5 shows a general workflow of the smart panorama “feature” (or method of use) as described herein, which could for example be implemented on (performed or carried out in) an electronic device such as device 400. The capture process starts with the capturing of a regular panorama image in step 502. A processing unit such as AP 430 receives a series of W (Wide) images as the user directs the W camera along the scene in step 504. The W images may be captured autonomously. The W images are processed by a RT module such as 436 to identify OOIs and ROIs in step 506. After ROIs are identified, in case of a 2D scanning camera, a processing unit may direct a high-resolution T camera to the region of interests in step 508. In case of a “centered FOV_{T} camera” (i.e. a T camera with a FOV_{T} centered with respect to the Wide FOV) with multiple zoom states, camera controller 444 may select a beneficial zoom state for capturing the T image during the regular panorama capture. Here, the term “beneficial zoom state” may refer to a zoom state that provides best user experience as described above. With the T camera directed towards the ROI, T images are captured in step 510. In case fault detection is performed and raises an error message, one may return to step 508, i.e. the processing unit may re-direct the high-resolution Tele camera to the ROI and capture it again. Eventually the W images are stitched by panorama module 448 to create a regular panorama image in step 512. In step 514, smart panorama module 450 decides which T images are to be included in the smart panorama and pins the chosen T images locations to the panorama image with very high resolution.

In some examples, image data of the T images captured in step 510 may be used for the regular panorama image.

In another embodiment with a centered FOV_{T} camera, the processing unit may determine the right timing for capturing the T image during the panorama capture.
determine the right timing for capturing the T image during the panorama capture.

FIG. 6A-B shows the localization of the T image within the W image. The localization may be performed in step 508 for directing a high resolution camera to an ROI or in step 514 for pinning a T image into a particular location in the panorama image. The T image may be captured by a scanning Tele camera or a non-scanning Tele camera.

In FIG. 6A, the scanning T FOV 602 is shown at an estimated POV within the Wide camera FOV 604. The scanning T FOV estimation with respect to the W FOV 604 is acquired by the Tele-Wide calibration information which in general may rely on position sensor measurements that provide OPFE position data. The T FOV estimation is calibration depended, it may be insufficiently accurate in terms of matching the T image data with the W image data. Typically, before the localization image points of a same object point may e.g. deviate by more than 25 pixels or by more than 50 pixels or by more than 100 pixels between the Wide and Tele camera. We assume a pixel size of about 1 μm. Tele localization is performed to improve the accuracy of the T FOV estimation over the W FOV. The localization process includes the following:
1. First, a search area 606 may be selected as shown in FIG. 6A. The selection may be based on the prior (calibration based) estimation. The search area may be defined by the FOV center of the prior estimation, which may be symmetrically embedded in a rectangular area, wherein the rectangular area may be for example twice or three times or four times the area covered by a T FOV.
2. The search area is cropped from the W FOV frame.
3. The next step may include template matching, wherein a source may be represented by the cropped search area and a template may be represented by the T FOV frame. This process may be performed by cross-correlation of the template over different locations of the search area or over the entire search area. The location with a highest matching value may indicate a best estimation of the T FOV location within the W FOV. In FIG. 2B, 608 indicates the final estimated Tele FOV after the localization.
   After the localization, image points of a same object point may typically deviate by less than 20 pixels, by less than 10 pixels, or even by less than 2 pixels between the Wide and Tele camera.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

What is claimed is:

1. A handheld device, comprising:
a first camera for capturing first images, each first image having a respective first field of view (FOV₁);
a second camera for capturing second images, each second image having a respective second FOV (FOV₂) that fulfills FOV₂<FOV₁; and
a processor configured to analyze the first images and/or the second images to define a specific location within a scene, to capture a particular second image of the specific location with the second camera, to stitch a plurality of first images into a panorama image with a field of view FOV_{P}>FOV₁, and to pin the particular second image to a given location within the panorama image to obtain a smart panorama.

2. The handheld device of claim 1, wherein the processor is configured to crop the particular second image before pinning it to the given location.

3. The handheld device of claim 2, wherein the particular second image is cropped according to aesthetic criteria.

4. The handheld device of claim 1, wherein the analysis of the first images and/or the second images includes calculating a saliency map.

5. The handheld device of claim 1, wherein the analysis of the first images and/or the second images includes tracking an object.

6. The handheld device of claim 1, wherein the analysis of the first images and/or the second images includes detecting a face.

7. The handheld device of claim 1, wherein the processor is configured to use a motion model that predicts a future movement of the handheld device and/or of an object within the FOV_{P}.

8. The handheld device of claim 1, wherein the processor is configured to perform fault detection by analysing a second image including the specific location within a scene.

9. The handheld device of claim 8, wherein, if an error is raised when performing the fault detection, the processor is configured to re-direct the second camera to the specific location within the scene and to re-capture another second image including the specific location.

10. The handheld device of claim 1, wherein the processor configuration to pin the particular second image to the given location within the panorama image includes a configuration to execute localization between a first image and the particular second image.

11. The handheld device of claim 10, wherein the execution of the localization reduces a deviation of the image points of a same object point in the particular second image and the panorama image by at least 5 times.

12. The handheld device of claim 10, wherein the execution of the localization reduces a deviation of the image points of a same object point in the particular second image and the panorama image by at least 2.5 times.

13. The handheld device of claim 1, wherein the second camera is a scanning camera.

14. The handheld device of claim 13, wherein the configuration to capture the second image of the specific location with the second camera includes a configuration to scan the FOV₂ to the specific location.

15. The handheld device of claim 13, wherein the scanning is performed by rotating an optical path folding element.

16. The handheld device of claim 1, wherein the first camera is configured to capture the first images autonomously.

17. The handheld device of claim 1, wherein the second camera is configured to capture the second images autonomously.

18. The handheld device of claim 1, wherein the second camera has a plurality of zoom states.

19. The handheld device of claim 1, wherein the handheld device is a smartphone.

20. The handheld device of claim 1, wherein the handheld device is a tablet.
